(19) United States
(12) Patent Application Publication
(10) Pub. No.: US 2007/0159439 A1
(43) Pub. Date: Jul. 12, 2007

(54) LIQUID CRYSTAL DISPLAY

(75) Inventor: Dong-Won PARK, Cheonan-si, Chungcheongnam-do (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD, Suwon-si (KR)

(21) Appl. No.: 11/621,647

(22) Filed: Jan. 10, 2007

(30) Foreign Application Priority Data
Jan. 10, 2006 (KR) 10-2006-0002880

(51) Int. Cl. G09G 3/36

(52) U.S. Cl. 345/98

(57) ABSTRACT

In a liquid crystal display, a timing controller compares a current pixel data signal corresponding to a currently driven gate line with a previous pixel data signal corresponding to a previously driven gate line to output control signals, and selectively outputs an output pixel data signal corresponding to the currently driven gate line. A data driver drives the data lines in response to the control signals and the output pixel data signal. Thus, the size of the pixel data signal provided from the timing controller to the data driver is reduced, thereby reducing power consumption and EMI thereof.

This application claims priority to Korean Patent Application No. 10-2006-0002880, filed on Jan. 10, 2006, and all the benefits accruing therefrom under 35 U.S.C. § 119, the contents of which in its entirety are herein incorporated by reference.

### BACKGROUND OF THE INVENTION

1. Field of the Invention

The present invention relates to a liquid crystal display. More particularly, the present invention relates to a liquid crystal display capable of reducing power consumption.

2. Description of the Related Art

In general, a liquid crystal display is representative of one type of portable flat panel display. A thin film transistor-liquid crystal display (“TFT-LCD”) which uses a thin film transistor (“TFT”) as a switching element has been mainly used in the liquid crystal display.

In the TFT-LCD, thin film transistors are generally formed corresponding to a plurality of pixels arranged in a matrix configuration. Pixel electrodes to which an image signal is applied under the control of the thin film transistors are formed in the pixels, respectively. A thin film transistor substrate is formed with gate lines connected to output terminals of a gate drive integrated circuit to supply a gate signal in order to control the pixels, and data lines connected to output terminals of a data drive integrated circuit to supply the image signal to the pixel electrodes. The gate lines are aligned while crossing the data lines, thereby defining the pixels in the matrix configuration. The above gate lines and the data lines are connected to each other through the pixel electrodes and the thin film transistors of the respective pixels.

The TFT substrate having the above-described arrangements operates as follows. As the gate lines are sequentially selected, a gate-on voltage in the form of a pulse is applied to the selected gate line, and voltages corresponding to pixel data are applied to the data lines, so that all of the pixels of the liquid crystal panel are driven.

Recently, with the improvement in resolution of a liquid crystal display, the number of pixels constituting the liquid crystal panel and the size of data required to display a frame have increased. However, as the amount of data transferred among internal circuits of the liquid crystal display becomes larger, power consumption and electromagnetic interference (“EMI”) are correspondingly increased.

### BRIEF SUMMARY OF THE INVENTION

The present invention provides a liquid crystal display capable of reducing an amount of data being transferred among internal circuits of the liquid crystal display.

In one exemplary embodiment of the present invention, a liquid crystal display includes a liquid crystal panel, a timing controller and a data driver. The liquid crystal panel includes a plurality of gate lines, a plurality of data lines arranged to cross the plurality of gate lines, and a plurality of pixels arranged in regions defined by the gate lines and the data lines. The timing controller compares a current pixel data signal corresponding to a currently driven gate line with a previous pixel data signal corresponding to a previously driven gate line generating a result of comparison, outputs control signals according to the result of comparison, and selectively outputs an output pixel data signal corresponding to the currently driven gate line. The data driver drives the data lines in response to the control signals and the output pixel data signal.

The timing controller includes a line memory outputting the previous pixel data signal and storing the current pixel data signal, an output controller comparing the current pixel data signal with the previous pixel data signal and generating an output control signal according to the result of comparison, an output circuit selectively outputting the current pixel data signal as the output pixel data signal in response to the output control signal and generating an OP-code corresponding to the output control signal, and an inverted signal generator comparing the current pixel data signal with the previous pixel data signal and generating an inverted signal according to a result of the comparison.

The output controller sets the output control signal to a first level when the current pixel data signal and the previous pixel data signal do not coincide with each other and do not have inversion relationship with each other, and the output circuit generates the OP-code of a first value when the output control signal is of the first level.

The current pixel data signal and the previous pixel data signal are pixel data signals for pixels of one horizontal line arranged in the liquid crystal panel.

The output controller sets the output control signal to a second level when all of the current pixel data signal and the previous pixel data signal coincide with each other, or when the current pixel data signal and the previous pixel data signal for a portion of the pixels coincide with each other and the current pixel data signal and the previous pixel data signal for the remaining pixels have the inversion relationship with each other, and the output circuit generates the OP-code of a second value when the output control signal is of the second level.

The data driver includes a shift register supplying a successive sampling signal, a data register storing the output pixel data signal from the output circuit in response to the sampling signal, a latch selectively latching the output pixel data signal output from the data register in response to the OP-code and the inverted signal, a digital-to-analog converter converting the output pixel data signal output from the latch into an analog pixel data signal, and an output buffer providing the analog pixel data signal from the digital-to-analog converter to the data lines.

The latch latches the output pixel data signal output from the data register when the OP-code has the first value, and does not latch the output pixel data signal output from the data register when the OP-code has the second value.

The inverted signal generator generates the inverted signal of the first level when the current pixel data signal and the previous pixel data signal for the respective pixels have complementary relationship with each other, and generates the inverted signal of the second level when the current pixel data signal and the previous pixel data signal for the respective pixels have non-complementary relationship with each other.

The latch inverts the output pixel data signal already latched to output the inverted output pixel data signal and does not receive a new input of the output pixel data signal from the data register when the inverted signal for the respective pixels has the first value, while the latch newly latches the output pixel data signal from the data register when the inverted signal for the respective pixels has the second value.

The control signals output from the timing controller include a latch signal, and the latch and the output buffer operate in synchronization with the latch signal.

The output circuit includes an OP-code generator receiving and transferring the current pixel data signal as its output signal and generating the OP-code corresponding to the output control signal, and a switching circuit outputting an output signal of the OP-code generator as the output pixel data signal in response to the output control signal.

The timing controller further outputs gate drive control signals, and the liquid crystal display further includes a gate driver successively driving the gate lines in response to the gate drive control signals.

### BRIEF DESCRIPTION OF THE DRAWINGS

The above and other advantages of the present invention will become readily apparent by reference to the following detailed description when considered in conjunction with the accompanying drawings wherein:

FIG. 1 is a schematic view illustrating a liquid crystal display according to an exemplary embodiment of the present invention;

FIG. 2 is a schematic view illustrating a pixel data signal generator provided in a timing controller illustrated in FIG. 1;

FIG. 3 is a schematic view illustrating a source driver illustrated in FIG. 2; and

FIGS. 4 to 7 are timing diagrams illustrating signals used in a pixel data signal generator and a source driver illustrated in FIG. 2 and FIG. 3.

### DETAILED DESCRIPTION OF THE INVENTION

Reference will now be made in detail to the exemplary embodiments of the present invention, examples of which are illustrated in the accompanying drawings. However, the present invention is not limited to the exemplary embodiments illustrated hereinafter, and the exemplary embodiments herein are rather introduced to provide easy and complete understanding of the scope and spirit of the present invention. Therefore, the present invention should not be construed as being limited to the exemplary embodiments set forth herein. Like reference numerals in the drawings denote like elements.

The terminology used herein is for the purpose of describing particular exemplary embodiments only and is not intended to be limiting of the present invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

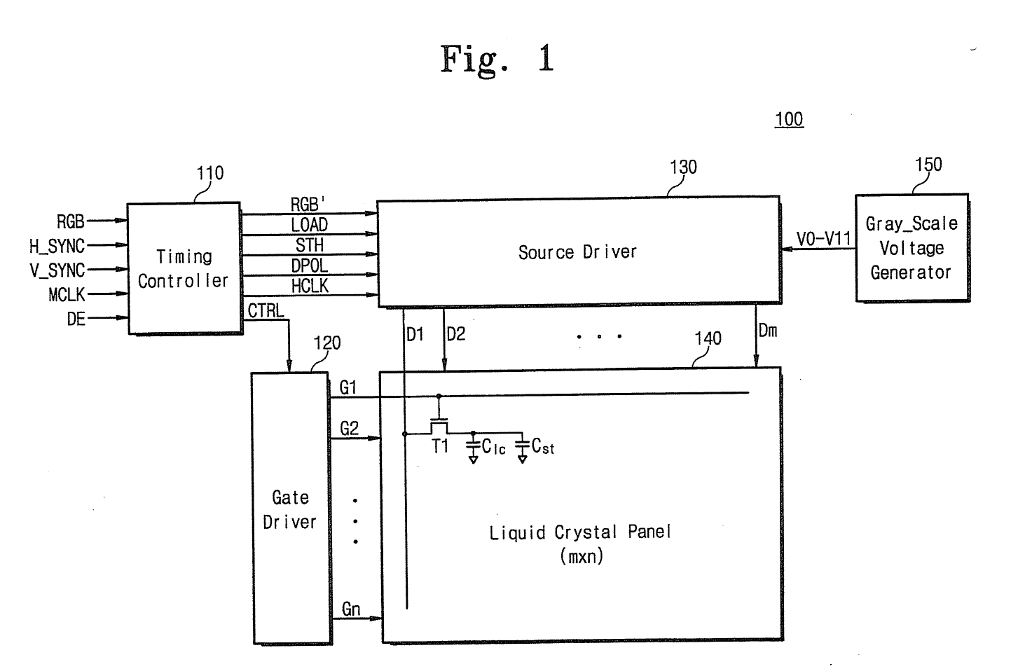

FIG. 1 is a schematic view illustrating a liquid crystal display according to an exemplary embodiment of the present invention.

Referring to FIG. 1, the liquid crystal display 100 includes a timing controller 110, a gate driver 120, a source driver 130, a liquid crystal panel 140 and a gray-scale voltage generator 150.

The liquid crystal panel 140 includes a plurality of gate lines G1-Gn, a plurality of data lines D1-Dm arranged to cross the plurality of gate lines G1-Gn, and a plurality of pixels arranged in regions defined by the gate lines G1-Gn and the data lines D1-Dm. Each of the pixels includes a thin film transistor T1 provided with a gate electrode and a source electrode connected to a corresponding gate line and a corresponding data line, respectively, a liquid crystal capacitor C_{LC} and a storage capacitor C_{ST} connected to a drain electrode of the thin film transistor T1. In such a pixel structure, the gate lines G1-Gn are sequentially selected by the gate driver 120, and when a gate-on voltage in a pulse form is applied to the selected gate line, the thin film transistor T1 connected to the corresponding gate line is turned on, and then a voltage that includes pixel information is applied to the data lines D1-Dm from the source driver 130. This voltage is applied to the liquid crystal capacitor C_{LC} and the storage capacitor C_{ST} through the thin film transistor of the corresponding pixel, and thus the liquid crystal capacitor C_{LC} and the storage capacitor C_{ST} are driven to perform a specified display operation.

The timing controller 110 receives a current pixel data signal RGB, a horizontal sync signal H₁₃ SYNC, a vertical sync signal V_SYNC, a clock signal MCLK and a data enable signal DE, from an external device. The timing controller 110 outputs the output pixel data signal RGB′, of which the data format has been converted to match interface specifications of the source driver 130, and control signals to the source driver 130. The control signals provided from the timing controller 110 to the source driver 130 may include a latch signal LOAD, a start horizontal sync signal STH, an inverted signal DPOL and a clock signal HCLK.

In addition, the timing controller 110 outputs control signals CTRL such as a start vertical sync signal, an output enable signal and a gate clock signal to the gate driver 120.

The gate driver 120 sequentially scans the gate lines G1-Gn of the liquid crystal panel 140 in response to the control signals CTRL provided from the timing controller 110. Here, the scanning puts the pixels of the gate line, to which the gate-on voltage VON has been applied, in a data recordable state by sequentially applying the gate-on voltage VON to each the gate lines G1-Gn.

The gray-scale voltage generator 150 provides gray-scale voltages corresponding to the output pixel data signal RGB′ to the source driver 130.

The source driver 130 drives the data lines D1-Dm of the liquid crystal panel 140 with the gray-scale voltages corresponding to the output pixel data signal RGB′ among the gray-scale voltages generated from the gray-scale voltage generator 150, in response to the control signals LOAD, STH, DPOL and HCLK, provided from the timing controller 110. Generally, the source driver 130 includes a plurality of integrated circuits.

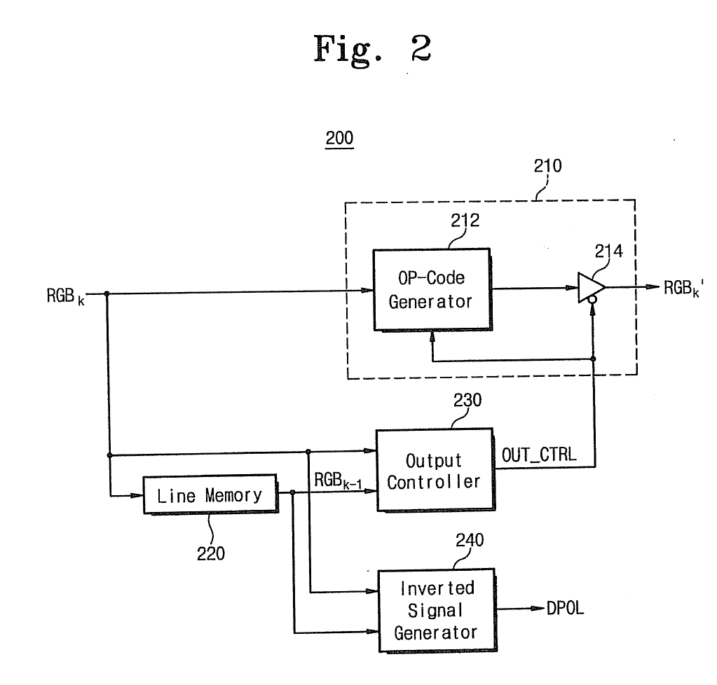

FIG. 2 is a view illustrating a pixel data signal generator 200 provided in the timing controller 110 illustrated in FIG. 1 according to the exemplary embodiment of the present invention.

Referring to FIG. 2, the pixel data signal generator 200 includes an output circuit 210, a line memory 220, an output controller 230 and an inverted signal generator 240. The output circuit 210 includes an OP-code generator 212 and a tri-state buffer 214.

A current pixel data signal RGBk, which is input from an outside source in correspondence with the currently driven gate line Gk, is transferred to the OP-code generator 212 and the line memory 220. The current pixel data signal RGBk corresponding to the currently driven gate line Gk refers to a pixel data signal to be provided to m pixels connected to the gate line Gk to which the gate-on voltage has been applied.

The line memory 220 compares the current pixel data signal RGBk corresponding to the currently driven gate line Gk with a previous pixel data signal RGBk−1 corresponding to a previously driven gate line Gk−1, and then outputs the output control signal OUT_CTRL. The output control signal OUT_CTRL is set to a low level when the output pixel data signal RGBk′ is necessary to be output as a result of comparison between the pixel data signals RGBk and RGBk−1. In contrast, the output control signal OUT_CTRL is set to a high level when the output pixel data signal RGBk′ is not necessary to be output.

The OP-code generator 212 generates an OP-code having a first value when the output control signal OUT_CTRL is the low level, and generates an OP-code having a second value when the output control signal OUT_CTRL is the high level.

The tri-state buffer 214 outputs an output signal of the OP-code generator 212 as the output pixel data signal RGBk′ in response to the output control signal OUT_CTRL from the output controller 230. The output pixel data signal RGBk′ includes the current pixel data signal RGBk and the OP-code, or includes only the OP-code.

The inverted signal generator 240 compares the current pixel data signal RGBk input from an outside with the previous pixel data signal RGBk−1 output from the line memory 220, and outputs an inverted signal DPOL according to the result of comparison. The inverted signal generator 240 outputs the inverted signal DPOL having a high level only when the current pixel data signal RGBk and the pixel data signal RGBk−1 for the respective pixels have a complementary relationship with each other, while otherwise, the inverted signal generator 240 outputs the inverted signal DPOL having a low level.

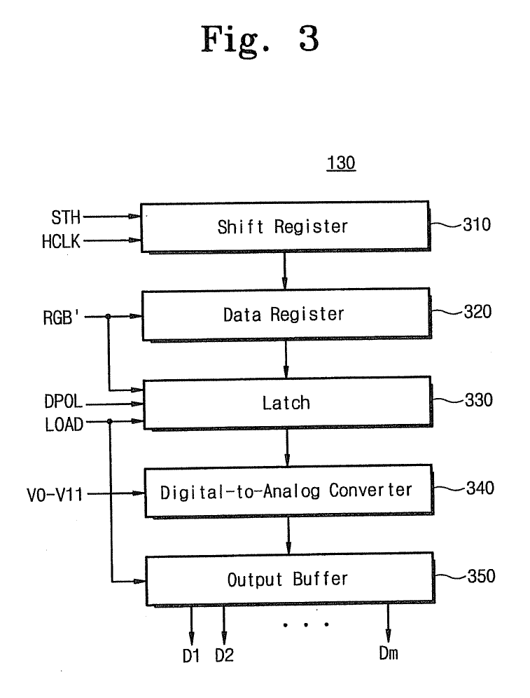

FIG. 3 is a schematic view illustrating the source driver 130 illustrated in FIG. 2 according to an exemplary embodiment of the present invention.

Referring to FIG. 3, the source driver 130 includes a shift register 310 supplying a successive sampling signal, a data register 320 storing the current pixel data in response to the sampling signal, a latch 330 latching the data output from the data register 320, a digital-to-analog converter 340 converting the digital pixel data output from the latch 330 into an analog signal, and an output buffer 350.

The shift register 310 successively shifts the start horizontal sync signal STH from the timing controller 110 according to the clock signal HCLK, and outputs the shifted start horizontal sync signal STH as the sampling signal.

The data register 320 sequentially samples and stores the output pixel data signal RGB′ from the timing controller 110 in a specific unit in response to the sampling signal from the shift register 310. In this exemplary embodiment, the size of the data register 320 is set to “the number of horizontal pixels*the number of bits of the respective pixel data”.

The latch 330 latches the output pixel data signal from the data register 320, and outputs the latched pixel data in response to the OP-code included in the output pixel data signal RGB′, the inverted signal DPOL and the latch signal LOAD from the timing controller 110. Since the inverted signal DPOL from the timing controller 110 is set to a high level or a low level in the unit of a pixel, the latch 330 inverts the output pixel data signal of which the corresponding inverted signal DPOL is at a high level among the latched pixel data signals.

In addition, if the OP-code included in the output pixel data signal RGB′ has the first value, the latch 330 newly latches the output pixel data signal from the data register 320 when the latch signal LOAD is activated. In contrast, if the OP-code included in the output pixel data signal RGB′ has the second value, the latch 330 does not newly latch the output pixel data signal from the data register 320, but maintains the stored value when the latch signal LOAD is activated.

The digital-to-analog converter 340 converts the output pixel data signal from the latch 330 into an analog pixel signal using gray-scale voltages V0-V11. The gray-scale voltages V0-V11 are generated by the gray-scale voltage generator 150. The output buffer 350 stores the analog pixel signal output from the digital-to-analog converter 340, and then provides the stored analog pixel signal to the data lines D1-Dm of the liquid crystal panel 140 in synchronization with the latch signal LOAD. For example, the latch 330 outputs the output pixel data signal from the data register 320 to the digital-to-analog converter 340 at a rising edge of the latch signal LOAD, and the output buffer 350 transfers an output of the digital-to-analog converter 340 to the data lines D1-Dm at a falling edge of the latch signal LOAD.

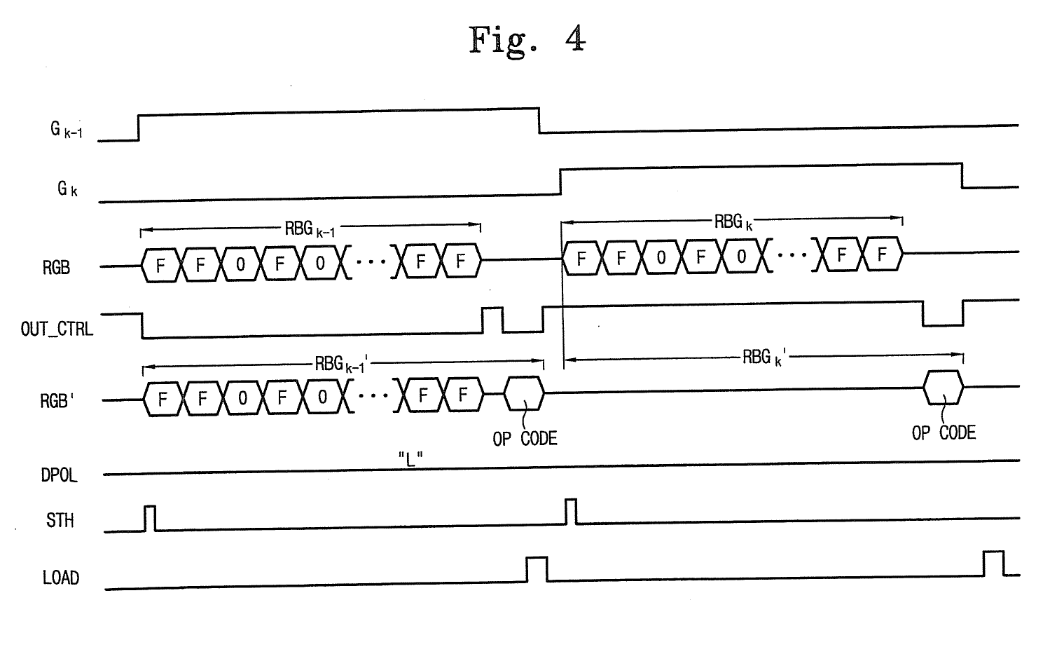

The operation of the pixel data signal generator 200 and the source driver 130 illustrated in FIG. 2 and FIG. 3 will be explained in detail with reference to timing diagrams shown in FIGS. 4 to 7.

Referring to FIGS. 4 to 7, when the (k−1)^{th} gate line Gk−1 is driven, control signals OUT_CTRL, RGBk′, and DPOL are determined according to the comparison result between the pixel data signal RGBk—2 corresponding to the (k—2)^{th} gate line Gk−2 and the pixel data signal RGBk−1 corresponding to the (k−1)^{th} gate line. However, in order to focus on the relationship between the pixel data signals RGBk−1 and RGBk corresponding to the (k−1)^{th} gate line Gk−1 and the k^{th} gate line Gk, respectively, the following description will be described on the assumption that the (k−1)th gate line Gk−1 is the first gate line G1 of one frame, and the pixel data signal RGBk−2 corresponding to the (k−2)^{th} gate line Gk−2 is different from the pixel data signal RGBk−1 corresponding to the (k−1)^{th} gate line, so they do not have inversion relationship with each other.

FIG. 4 is a timing diagram of signals output from the timing controller 110 when the previous pixel data signal RGBk−1 and the current pixel data signal RGBk completely coincide with each other.

Referring to FIG. 4, if the gate line Gk is driven in a state that the previous pixel data signal RGBk−1 and the current pixel data signal RGBk coincide with each other, the output control signal OUT_CTRL is set to a high level, the OP-code has the second value, and the inverted signal DPOL is set to the low level by the pixel data signal generator as illustrated in FIG. 2.

Accordingly, the output pixel data signal RGBk′ output from the pixel data signal generator 200 of FIG. 2 does not include the pixel data signal, but includes only the OP-code. Also, the latch 330 illustrated in FIG. 3 does not receive a new output pixel data signal from the data register 320, but outputs the latched output pixel data signal to the digital-to-analog converter 340 at a rising edge of the latch signal LOAD.

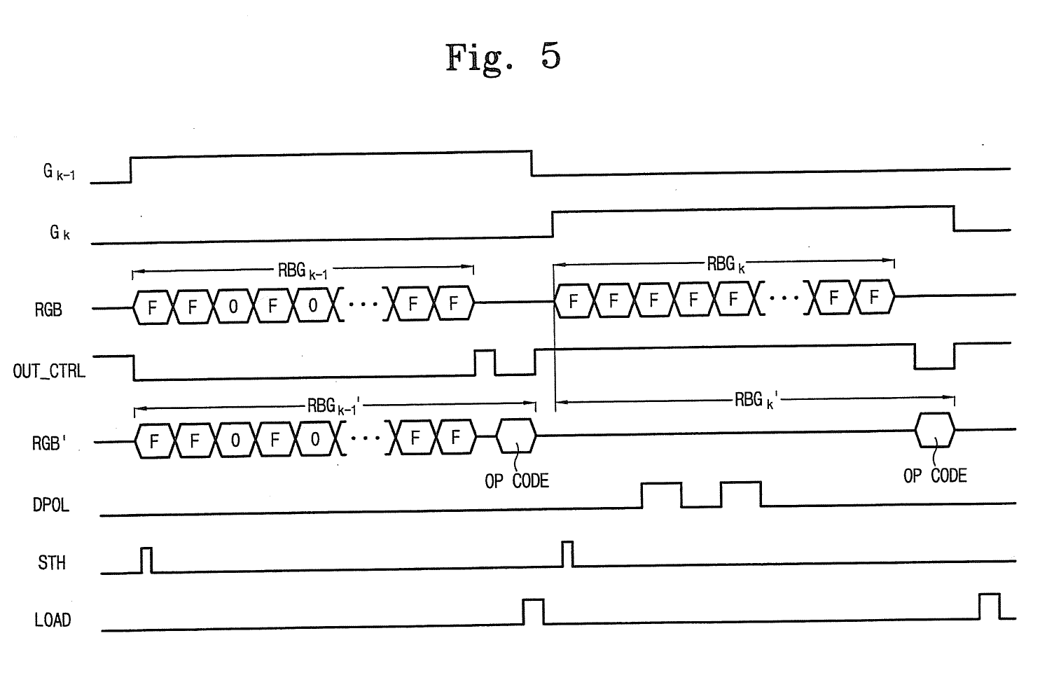

FIG. 5 is a timing diagram of signals output from the timing controller 110 illustrated in FIG. 1 when some data signals of the pixel data signals RGBk−1 and RGBk corresponding to two adjacent gate lines Gk−1 and Gk coincide with each other, and the remaining data signals thereof have inversion relationship with each other.

As shown in FIG. 5, the pixel data signal RGBk−1 is “FF0F0 . . . FF”, and the current pixel data signal RGBk is “FFFFF . . . FF”. Accordingly, if the pixel data signal “0” is inverted into the pixel data signal “F”, the two pixel data signals RGBk−1 and RGBk become identical to each other.

Accordingly, when the gate line Gk is driven, the output control signal OUT_CTRL is set to the high level, and the OP-code has the second value. Also, the inverted signal DPOL is set to the low level in a period where the pixel data signals RGBk—1 and RGBk coincide with each other, while the inverted signal DPOL is set to the high level in a period where the pixel data signals have inversion relationship with each other.

In this case, the pixel data signal generator 200 of FIG. 2 does not output the output pixel data signal RGBk′, and the latch 330 illustrated in FIG. 3 does not receive a new output pixel data signal from the data register 320 at a rising edge of the latch signal LOAD. Also, the latch 330 outputs the output pixel signal corresponding to the low level of the inverted signal DPOL among the latched output pixel data signals to the digital-to-analog converter 340, while the latch inverts the output pixel data signal corresponding to the high level of the inverted signal DPOL to output the inverted output pixel data signal to the digital-to-analog converter 340.

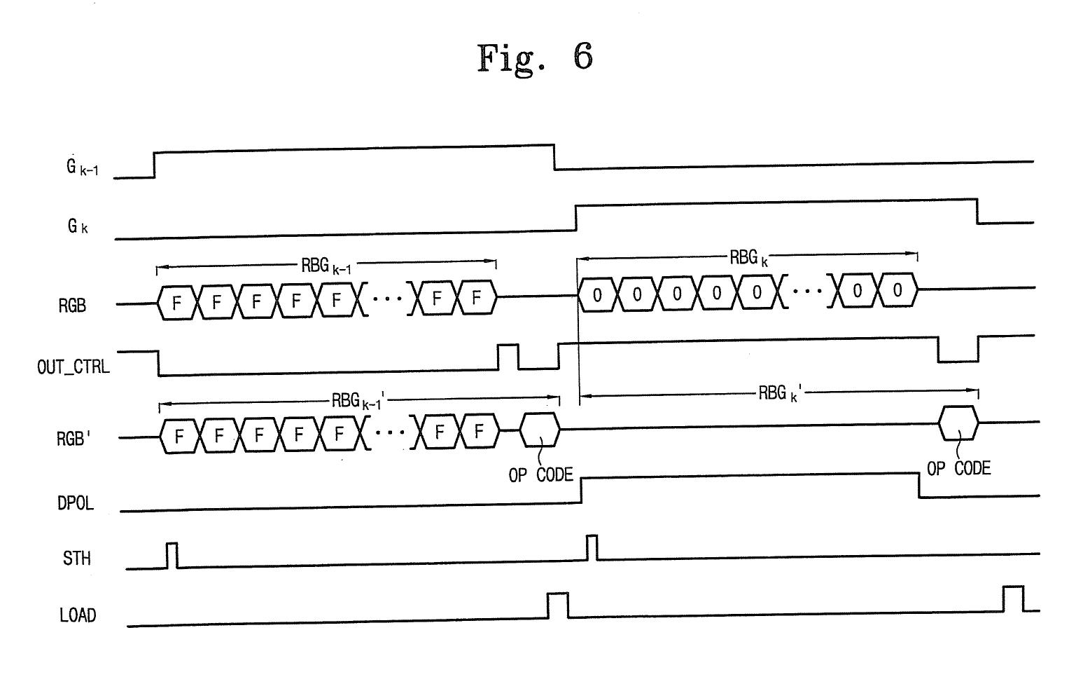

FIG. 6 is a timing diagram of signals output from the timing controller 110 illustrated in FIG. 1 when the pixel data signals RGBk−1 and RGBk corresponding to two adjacent gate lines Gk−1 and Gk generally have inversion relationship with each other.

Referring to FIG. 6, the pixel data signal RGBk−1 is “FFFFF . . . FF”, and the current pixel data signal RGBk is “00000 . . . 00”. Accordingly, if the pixel data signal RGBk−1 is inverted, it becomes equal to the pixel data signal RGBk.

Accordingly, when the gate line Gk is driven, the output control signal OUT_CTRL is set to the high level, the OP-code has the second value, and the inverted signal DPOL is set to the high level.

In this case, the pixel data signal generator 200 of FIG. 2 does not output the output pixel data signal RGBk′, and the latch 330 illustrated in FIG. 3 does not receive a new output pixel data signal from the data register 320 at a rising edge of the latch signal LOAD, but inverts the latched output pixel data signal to output the inverted pixel data signal to the digital-to-analog converter 340.

As described above, when the previous pixel data signal RGBk−1 and the current pixel data signal RGBk completely coincide with each other, part of the pixel data signals coincide with each other and the remaining part have inversion relationship with each other, and the pixel data signals have inversion relationship with each other, the output pixel data signal RGB′ transmitted from the timing controller 110 to the source driver 130 does not include the pixel data signal, but includes the OP-code only. In these cases, the size of data transmitted from the timing controller 110 to the source driver 130 is reduced, resulting in a reduction of power consumption and electromagnetic interference (“EMI”).

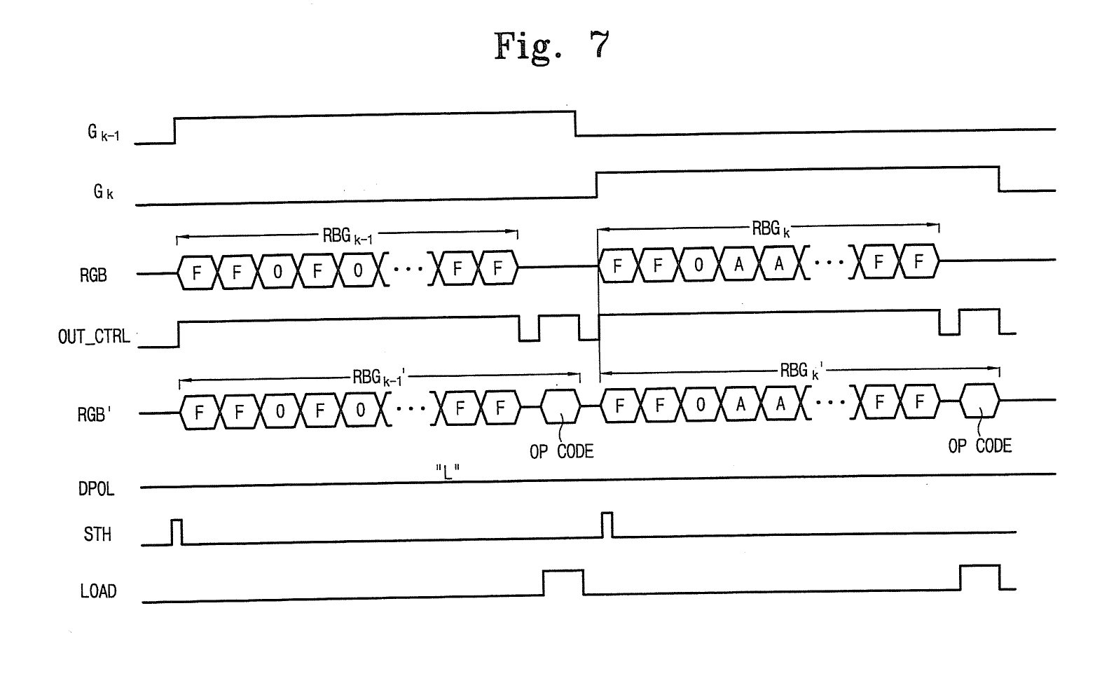

FIG. 7 is a timing diagram of signals output from the timing controller 110 illustrated in FIG. 1 when the pixel data signals RGBk−1 and RGBk corresponding to two adjacent gate lines Gk−1 and Gk neither coincide with each other nor have inversion relationship with each other.

Referring to FIG. 7, since the pixel data signal RGBk−1 s “FF0F0 . . . FF”, and the current pixel data signal RGBk is “FF0M . . . FF”, they are different from each other.

Accordingly, when the gate line Gk is driven, the output control signal OUT_CTRL is set to a low level, the OP-code has the first value, and the inverted signal DPOL is set to a low level “L”.

In this case, the pixel data signal generator 200 of FIG. 2 outputs the output pixel data signal RGBk′, and the latch 330 illustrated in FIG. 3 receives a new output pixel data signal from the data register 320 at a rising edge of the latch signal LOAD and outputs the new output pixel data signal to the digital-to-analog converter 340.

According to the present invention, the size of the pixel data signal provided from the timing controller to the source driver is reduced, thus resulting in reduced power consumption and EMI.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A liquid crystal display comprising:
a liquid crystal panel including a plurality of gate lines, a plurality of data lines arranged to cross the plurality of gate lines, and a plurality of pixels arranged in regions defined by the gate lines and the data lines;
a timing controller comparing a current pixel data signal corresponding to a currently driven gate line with a previous pixel data signal corresponding to a previously driven gate line generating a result of comparison, outputting control signals according to the result of comparison, and selectively outputting an output pixel data signal corresponding to the currently driven gate line; and
a data driver driving the data lines in response to the control signals and the output pixel data signal.

2. The liquid crystal display of claim 1, wherein the timing controller comprises:
a line memory outputting the previous pixel data signal and storing the current pixel data signal;
an output controller comparing the current pixel data signal with the previous pixel data signal and generating an output control signal according to the result of comparison;
an output circuit selectively outputting the current pixel data signal as the output pixel data signal in response to the output control signal and generating an OP-code corresponding to the output control signal; and
an inverted signal generator comparing the current pixel data signal with the previous pixel data signal and generating an inverted signal according to the result of comparison.

3. The liquid crystal display of claim 2, wherein the output controller sets the output control signal to a first level when the current pixel data signal and the previous pixel data signal do not coincide with each other and do not have inversion relationship with each other, and the output circuit generates the OP-code of a first value when the output control signal is of the first level.

4. The liquid crystal display of claim 2, wherein the current pixel data signal and the previous pixel data signal are pixel data signals for pixels of one horizontal line arranged in the liquid crystal panel.

5. The liquid crystal display of claim 4, wherein the output controller sets the output control signal to a second level when all of the current pixel data signal and the previous pixel data signal coincide with each other, or when the current pixel data signal and the previous pixel data signal for a portion of the pixels coincide with each other and the current pixel data signal and the previous pixel data signal for the remaining pixels have the inversion relationship with each other; and
the output circuit generates the OP-code of a second value when the output control signal is of the second level.

6. The liquid crystal display of claim 4, wherein the data driver comprises:
a shift register supplying a successive sampling signal;
a data register storing the output pixel data signal from the output circuit in response to the sampling signal;
a latch selectively latching the output pixel data signal output from the data register in response to the OP-code and the inverted signal;
a digital-to-analog converter converting the output pixel data signal output from the latch into an analog pixel data signal; and
an output buffer providing the analog pixel data signal from the digital-to-analog converter to the data lines.

7. The liquid crystal display of claim 6, wherein the latch latches the output pixel data signal output from the data register when the OP-code has the first value, and does not latch the output pixel data signal output from the data register when the OP-code has the second value.

8. The liquid crystal display of claim 6, wherein the inverted signal generator generates the inverted signal of the first level when the current pixel data signal and the previous pixel data signal for the respective pixels have complementary relationship with each other, and generates the inverted signal of the second level when the current pixel data signal and the previous pixel data signal for the respective pixels have a non-complementary relationship with each other.

9. The liquid crystal display of claim 8, wherein the latch inverts the output pixel data signal already latched to output the inverted output pixel data signal and does not receive a new input of the output pixel data signal from the data register when the inverted signal for the respective pixels has the first value, while the latch newly latches the output pixel data signal from the data register when the inverted signal for the respective pixels has the second value.

10. The liquid crystal display of claim 6, wherein the control signals output from the timing controller include a latch signal; and
the latch and the output buffer operate in synchronization with the latch signal.

11. The liquid crystal display of claim 2, wherein the output circuit comprises:
an OP-code generator receiving and transferring the current pixel data signal as its output signal and generating the OP-code corresponding to the output control signal; and
a switching circuit outputting an output signal of the OP-code generator as the output pixel data signal in response to the output control signal.

12. The liquid crystal display of claim 1, wherein the timing controller further outputs gate drive control signals; and
the liquid crystal display further comprises a gate driver successively driving the gate lines in response to the gate drive control signals.
